(19) United States
(12) Patent Application Publication
(10) Pub. No.: US 2022/0175185 A1
(43) Pub. Date: Jun. 9, 2022

(54) FILTER APPARATUS FOR A KITCHEN APPLIANCE AND KITCHEN APPLIANCE

(71) Applicant: VORWERK & CO. INTERHOLDING GMBH, Wuppertal (DE)

(72) Inventors: Felix Thies, Wuppertal (DE); Torsten Lang, Solingen (DE)

(21) Appl. No.: 17/540,652

(22) Filed: Dec. 2, 2021

(30) Foreign Application Priority Data
Dec. 3, 2020 (DE) 102020215267.5

(51) Int. Cl. A47J 36/38; A47J 43/046; A47J 43/07; A47J 27/00; A47J 43/08; A47J 36/06; B01D 29/11; B01D 39/20

(52) U.S. Cl. CPC A47J 36/38; A47J 43/046; A47J 43/0722; B01D 39/2055; A47J 43/085; A47J 36/06; B01D 29/11; A47J 27/004

(57) ABSTRACT

A kitchen appliance for the preparation of food includes a filter apparatus. The filter apparatus filters steam generated during food preparation using the kitchen appliance.

### CROSS-REFERENCE TO RELATED APPLICATIONS

This application claims priority to and benefit of German Application No. 102020215267, filed Dec. 3, 2020, the disclosure of which is hereby incorporated in its entirety by reference herein.

### TECHNICAL FIELD

The disclosure relates to a filter apparatus for a kitchen appliance for filtering steam from a food preparation with the kitchen appliance and to a kitchen appliance for preparing food in a food preparation vessel.

### BACKGROUND

Present day kitchen appliances have a lid to prevent the user from reaching into the food preparation vessel and injuring himself or herself on the rotating tool. The lid usually has a circular central opening that allows ingredients to be added during food preparation. The diameter of this opening is narrowly limited so that it is not possible to reach in and thus the risk of injury is minimized.

### SUMMARY

In particular during cooking processes, steam flows out of the opening. The steam, on the one hand, can be undesirable due to condensation on e.g. kitchen cabinets or in the air. On the other hand, the steam often contains odors that are frequently undesirable, at least in living areas. Particularly in modern, open kitchens, a reduction of the odors released is desirable in order to affect the rest of the home as little as possible. Accordingly, there is a need for releasing the steam generated by kitchen appliances in a way that is as odorless as possible.

### BRIEF DESCRIPTION OF DRAWINGS

FIG. 1: a side view of a filter apparatus on a kitchen appliance,

FIG. 2: a plan view of the filter apparatus of FIG. 1,

FIG. 3: a schematic sectional drawing of a filter apparatus,

FIG. 4: a schematic sectional drawing of a further filter apparatus,

FIG. 5: a schematic side view of a filter apparatus,

FIG. 6: a schematic side view of a further filter apparatus,

FIG. 7: a view of a filter bag,

FIG. 8: a view of a filter element,

FIG. 9: an exploded view of a filter apparatus,

FIG. 10: a perspective view of a filter apparatus,

FIG. 11: a kitchen appliance with a filter apparatus, and

FIG. 12: a kitchen appliance with another filter apparatus.

### DETAILED DESCRIPTION

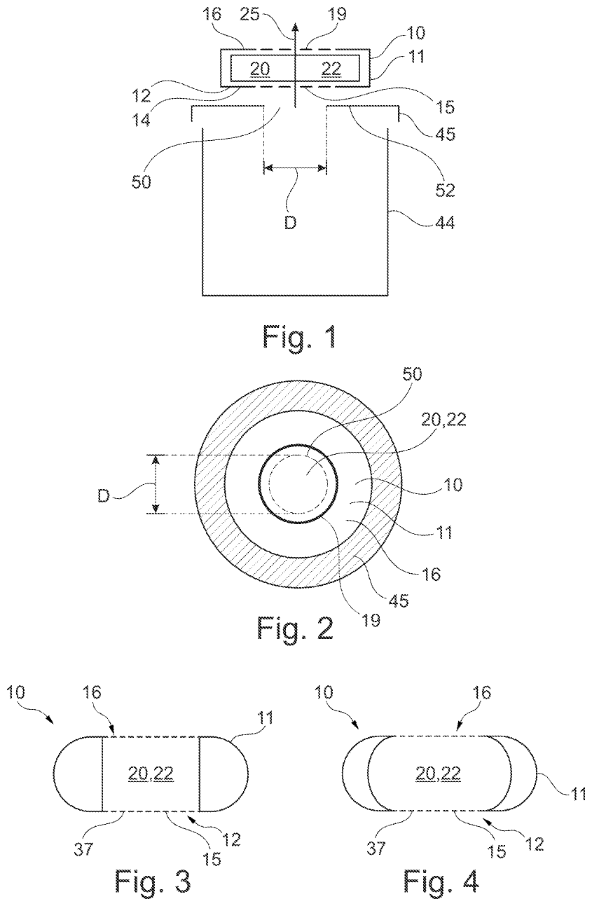

FIG. 1 shows a schematic sectional drawing of a filter apparatus 10 arranged on a lid 45 of a food preparation vessel 44. FIG. 2 shows the corresponding plan view. The filter apparatus 10 is shown in the manner of an exploded view above the lid 45, and the lid 45 is shown correspondingly above the food preparation vessel 44. When used as intended, the filter apparatus 10 rests with the contact surface 14 located on its underside 12 on the lid 45 in a flat and circumferential manner. The lid 45 forms an opening 50 with a diameter D 6 cm. With regard to the main direction of flow 25, the contact surface 14 lies radially circumferentially on the material 52 of the lid 45 forming the opening 50.

The filter apparatus comprises an outer housing 11 made of plastic with an upper side 16 and an underside 12. The outer housing 11 has a circular shape which extends rotationally symmetrically with respect to the main direction of flow 25. The circular inflow opening 15 is arranged centrally on the underside 12 and the circular outflow opening 19 is arranged centrally on the upper side. The steam generated during a food preparation process flows vertically upward through the opening 50, through the inflow opening 15 into the space 20 filled with the filter material 22 inside the filter apparatus 10, and exits the filter apparatus 10 vertically upward through the outflow opening 19.

The filter apparatus 10 has an outer diameter of the outer housing 11 of about 15 cm. The outer housing 11 is made of hard plastic and cannot be pushed through the opening 50. Said diameter is the largest extension of the filter apparatus 10. The filter apparatus 10 covers the opening 50 completely. In FIG. 2, the covered edge of the opening 50 is shown as a dashed line. The inflow opening 15 and the outflow opening 19 also completely cover the opening 50.

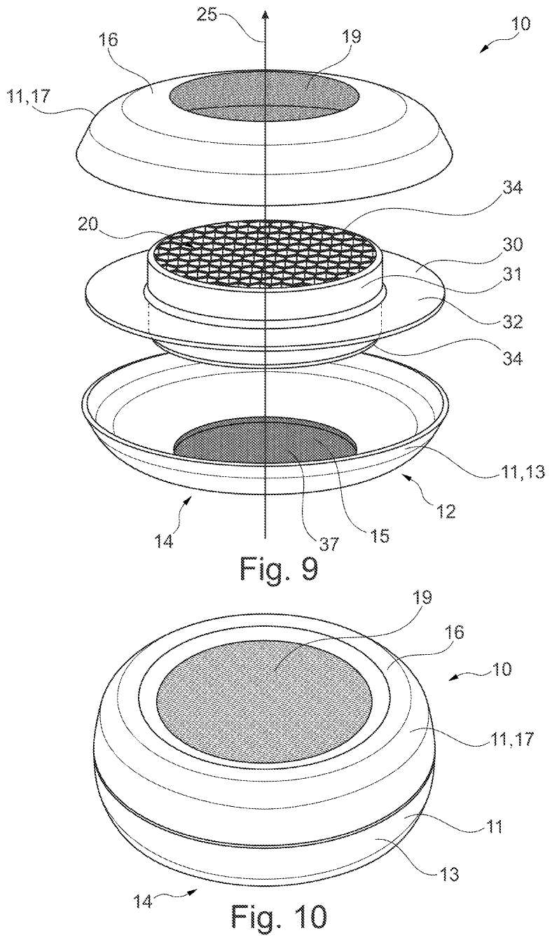

The FIGS. 3 and 4 show sectional views of various filter apparatuses 10. These are similar in design to the filter apparatuses 10 shown in FIGS. 1 and 2, and therefore in all other respects reference is made to the above descriptions. The filter apparatuses 10 each comprise a housing 11 in which the space 20 containing the filter material 22 is arranged. The housing 11 is formed in a rotationally symmetrical manner analogous to the FIGS. 1 and 2, but is convexly curved on the outer sides. The inflow opening 15 arranged on the underside 12 is closed with a grille 37, namely a wire grille. This will be discussed in more detail with reference to FIG. 9 below. The space 20 with the filter material 22 is circular-cylindrical in shape in FIG. 3 and extends with a straight wall between the inflow opening 15 and the outflow opening. In contrast, in FIG. 4, the space 20 is bulbous in shape and extends with concavely curved outer walls between the inflow opening 15 and the outflow opening. In this way, the volume of the space 20 is larger and the volume not used, which is inside the filter apparatus 10 but outside the space 20, is smaller. In general, the outflow opening can also be arranged on the side. There can be several outflow openings, which can be arranged distributed around the circumference, for example.

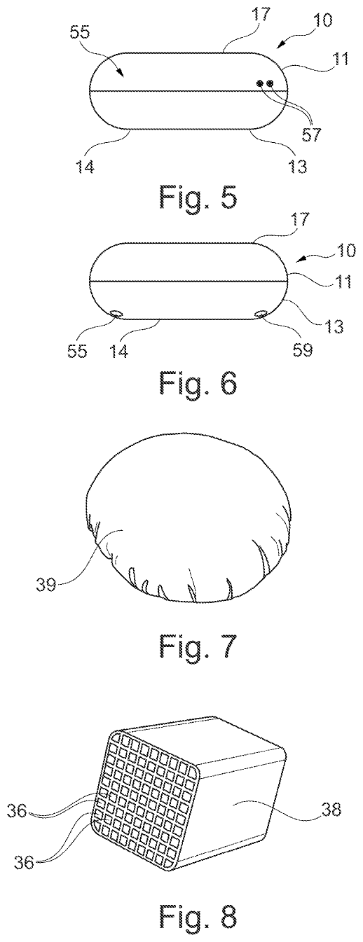

FIGS. 5 and 6 show side views of embodiments of filter apparatuses 10 according to the disclosure. These have a two-part housing 11 made of plastic, which is composed of an upper housing part 17 and a lower housing part 13. These parts can be mechanically connected to and disconnected from each other, in particular by means of a bayonet lock. In this way, the housing 11 can be opened in order to replace the filter material.

In FIG. 5, the filter apparatus 10 comprises a blower 55 in its inside, which realizes an air flow between the inflow opening on the underside 12 and the outflow opening on the upper side. Thus, the flow of steam through the filter apparatus 10 is facilitated. The filter apparatus 10 has two electrical contacts 57 on the outside of the housing 11 for supplying power to the electric motor of the blower 55. Alternatively, for this purpose, a rechargeable battery can be arranged inside the housing, which can be replaced by opening the housing.

In FIG. 6, holes 59 are arranged in the lower housing part 13 radially outside the inflow opening. Through these holes, condensed water, which is located in a peripheral inner area of the filter apparatus 10, which is outside the space for receiving the filter material, can drain off.

FIG. 7 schematically shows a filter bag 39. This bag has a circular cross-section and contains granulated activated carbon. The outer wall of the filter bag 39 is formed by a vapor-permeable fabric. The filter bag 39 is inserted into the space 20 shown, for example, in FIGS. 1, 3 and 4. In particular, the housing can be opened and closed in order to replace the filter bag 39.

FIG. 8 shows an example of a filter element 38, which is a porous solid body, in particular made of activated carbon, which is traversed by a multitude of channels 36. Steam can flow through these channels in order to be filtered. The filter element 38 may be replaceably arranged in the space and/or permanently mounted therein. In an embodiment, the filter housing 31 with the internal channel structure, shown for example in FIG. 10, can be provided inexpensively by an appropriately sized filter element 38.

FIGS. 9 and 10 show a further embodiment of the filter apparatus 10, wherein FIG. 9 is an exploded view. The filter apparatus 10 comprises a housing 11 with an upper housing part 17 and a lower housing part 13, as well as a rotationally symmetrical filter unit D arranged therebetween. The upper housing part 17 can be reversibly connected to the filter unit 30 by fastening means not shown, in the manner of a bayonet lock. The lower housing part 13 can be reversibly connected to the filter unit 30 by fastening means not shown, in the manner of a bayonet lock. The upper housing part 17 and the lower housing part 13 are in particular at least substantially identically formed.

On the underside 12 of the filter apparatus 10 formed by the lower housing part 13 there is the inflow opening 15, which is covered with a metal sieve. The metal sieve meshes form in a way a plurality of inflow openings 15. The metal sieve serves as a grille 37, which intercepts grease and oil droplets or at least partially prevents them from reaching the filter material. The upper side 16 with the outflow opening 19 is formed accordingly. In particular, the upper housing part 17 and the lower housing part 13 are configured such that they can be washed and/or cleaned in the dishwasher.

The filter unit 30 comprises a filter housing 31 which contains the filter material. The filter housing 31 has a circular cylindrical wall and extends along the main direction of flow 25. The upper and lower openings of the filter housing 31 are closed with a grid having a honeycomb structure so that the filter material is retained firmly. Steam can flow in and out through the openings in the grille. In an embodiment, a circumferential gasket 34 is arranged in each of the upper and lower end regions of the wall which separates the space 20 containing the filter material from the peripheral interior region of the filter apparatus 10 located outside the space 20. In the closed position of the housing 11, the upper gasket presses against the upper housing part 17 and encloses the outflow opening. The same applies to the lower gasket. This prevents steam from entering the peripheral inner region.

The filter unit 30 comprises a fastening section 32 protruding radially outward from the wall of the filter housing 31, which is formed as a circumferential disk extending in a horizontal plane. The fastening section 32 is made of plastic, for example plexiglass. It is arranged between the upper housing part 17 and the lower housing part 13. It is held by the outer housing 11. Alternatively or additionally, the fastening section 31 can also serve to simplify handling, for example when replacing the filter unit 30. FIG. 10 shows the filter apparatus 10, in particular that of FIG. 9, in the closed position.

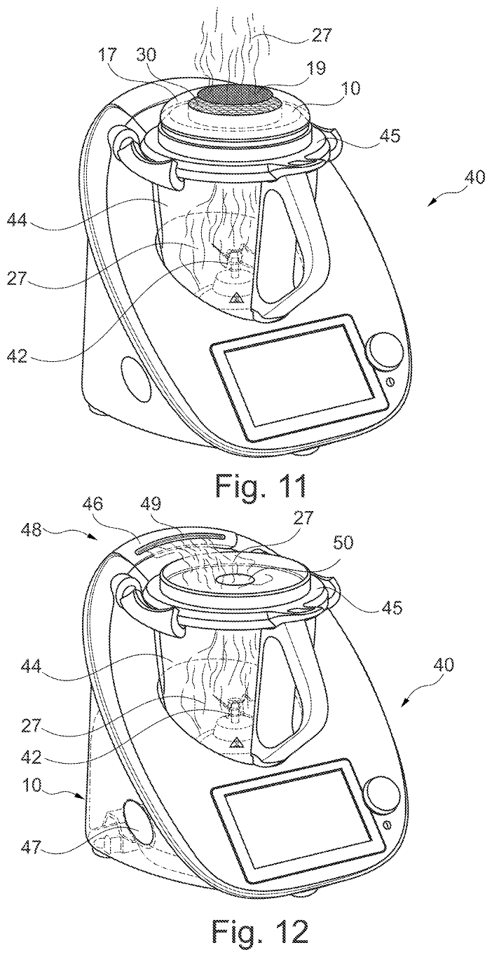

FIG. 11 shows a kitchen appliance 40 for preparing food in a food preparation vessel 44. The kitchen appliance 40 comprises a heating element for heating the food in the food preparation vessel 44 and a rotatable tool 42 for mixing or comminuting the food in the food preparation vessel 44 as well as the removable food preparation vessel 44. The kitchen appliance 40 further comprises the filter apparatus 10, for example as shown in FIG. 10, for filtering steam 27 generated during a food preparation process from the food preparation vessel 44. For improved clarity, the food preparation vessel 44 and the upper housing part 17 of the filter apparatus 10 are shown partially transparent.

The kitchen appliance 40 comprises a lid 45 that removably covers the food preparation vessel 44 and has an opening with a maximum diameter of 6 cm. The filter apparatus 10 is positioned on the lid 45 and covers the opening completely. A circumferential contact surface of the filter apparatus 10 rests on the material 52 of the lid 45 in a flat and substantially sealing manner, so that steam 27 which exits the food preparation vessel 44 upwardly through the opening is filtered almost completely. It flows into the filter apparatus 10, passes through the filter unit 30 with the filter material and leaves the filter apparatus 10 upwards through the outflow opening 19 in a purified form.

FIG. 12 shows a kitchen appliance 40 having a suction device 48. The kitchen appliance 40 is configured like the kitchen appliance 40 shown in FIG. 11, but does not include a filter apparatus 10 positioned on the lid 45. In the embodiment as shown here, the filter apparatus 10 is arranged inside the housing of the kitchen appliance 40. It can be designed to be replaceable and accessible from the outside so that it can be replaced when the filter material is loaded.

The suction device 49 comprises a suction opening 49, which is arranged in the carrying handle 46 of the kitchen appliance 40. Generated steam 27 is sucked in through this opening. The suction opening 49 is slit-shaped and follows the curved contour of the carrying handle 46. An exhaust air grille protects the suction opening 49 and forms a part of the outer contour of the carrying handle 46. The drawn-in steam 27 is directed to the filter apparatus 10 through an exhaust air duct inside the carrying handle as well as the housing of the kitchen appliance 40. An air flow for drawing in the steam is generated by a blower which is driven by an electric motor. This may be the electric motor for driving the tool 42 or a separate electric motor.

The steam 27 thus conveyed flows into the filter apparatus through an inflow opening, is filtered by the filter material located in the filter apparatus, and flows out of the filter apparatus again through an outflow opening. The suction device can be configured such that the filtered steam 27 flows out of the outflow opening directly to the outside. In this case, the outflow opening of the filter apparatus is also the air outlet 47 of the suction device. Alternatively, an exhaust air duct may additionally be disposed between the exhaust air opening and the air outlet 47. The kitchen appliance may further comprise a device for separating water from the steam 27, which may comprise a cooling element for cooling the steam for the purpose of condensing the water contained therein.

Accordingly, it is the object of the disclosure to provide a filter apparatus for a kitchen appliance and a further improved kitchen appliance.

In order to solve the problem, a filter apparatus for a kitchen appliance is used for filtering steam from food preparation with the kitchen appliance. The filter apparatus has an inflow opening for steam on an underside of the filter apparatus. The filter apparatus encloses a space for receiving a filter material for filtering steam. The filter apparatus is dimensioned such that the filter apparatus can cover a circular opening with a diameter of 6 cm. The filter apparatus is configured such that the filter apparatus cannot be pushed through the opening. The filter apparatus has a maximum dimension of 22 cm, preferably 15.5 cm.

By dimensioning the filter apparatus such that the filter apparatus can cover a circular opening with a diameter of 6 cm, it is ensured that a sufficient amount of the filter material can be provided in the filter apparatus to filter steam sufficiently for at least one cooking process. A replacement of the filter or a filter cleaning during a cooking process can thus be avoided. On the other hand, limiting the largest extension of the filter apparatus to a maximum of 22 cm, preferably to a maximum of 15.5 cm, avoids having filter material in peripheral areas in which the filter material does not contribute significantly to the filtration and consequently increases the manufacturing costs in an unnecessary way. Furthermore, this can reduce the risk of mold formation especially in peripheral areas of the filter material.

During operation, the steam is released in a kind of channelled flow through the opening of the lid of a kitchen appliance and enters the filter apparatus through the inflow opening. The steam flows through the filter material to a large extent in the area of the opening, i.e. centrally with regard to the filter apparatus. Filter material arranged centrally is thus streamed through to the greatest extent. It has been shown that above an extension of the filter apparatus of 22 cm, the outer filter material does not contribute to filtration, or contributes only to a negligible extent to filtration. At an extension of 15.5 cm, the outer filter material contributes to the filtration process to a small extent, and at an extension of 22 cm even less. By limiting the largest extension of the filter apparatus as indicated, the filter material contributes to the filtration effectively and to a high extent.

In an embodiment, the filter apparatus has a largest extension that is between 12 cm and 22 cm. This allows a filter capacity for several boiling processes with a comparatively highly efficient use of the filter material provided. In an embodiment, the largest extension is 12 cm in order to allow the filter material to be used highly efficiently.

The underside is located at the bottom when used as intended. Steam to be filtered can flow from the opening on the underside into the filter apparatus through the inflow opening. In particular, the steam to be filtered flows into the filter apparatus along a main direction of flow extending vertically from the bottom to the top, through the filter apparatus and/or out of the filter apparatus. The filter apparatus has a central axis. The central axis extends from the underside to the upper side of the filter apparatus. The central axis is positioned in the middle when viewed from above, i.e. it is central to the filter apparatus. A surface of the filter apparatus projected in plan view has a center in the middle through which the central axis extends. The center axis extends in particular parallel to the main direction of flow. Preferably, the main direction of flow extends along the central axis, in particular when the inflow and outflow openings are centrally arranged.

The filter apparatus is suitable for filtering steam. The filter apparatus may also be suitable for filtering odors from air containing odors or exhaust air from food preparation with a kitchen appliance, i.e., filtering air containing odors generated during the preparation or processing of the food with or without heat.

The largest extension is the maximum extent of the filter apparatus measured along a straight line. In particular, the filter apparatus is designed such that the greatest extent is parallel to the horizontal plane. The horizontal plane is oriented perpendicular to the main direction of flow.

A filter apparatus that is dimensioned such that the filter apparatus can cover a circular opening with a diameter of 6 cm has an extension of more than 6 cm. A filter apparatus that is configured such that the filter apparatus cannot be pushed through the opening cannot be pushed through the opening in a non-destructive manner by hand force. The filter apparatus cannot be pushed completely through the opening. However, it may be possible to push or slide a section of the filter apparatus into the opening. In particular, the filter apparatus has a structure of such rigidity that deformation is not possible or is possible only to such a small extent that the filter apparatus is always retained by the opening even when a manual force is applied. The largest extension is preferably more than 7 cm, preferably more than 9 cm. In this way, a sufficient amount of filter material can be provided for more than a single cooking operation. In this application, dimensions have an accuracy of 5%.

The underside may have an extension measured in a horizontal plane which corresponds to the largest extension, e.g. a maximum of 15.5 cm. The underside may be half-shell-shaped. Preferably, the underside is U-shaped and/or curved. The underside may also comprise a flat bottom portion. In another embodiment, the underside comprises a protrusion projecting downwardly, preferably having the inflow opening centrally. The protrusion preferably has a largest extension in a horizontal plane, i.e., measured transversely to the main direction of flow or central axis, which is smaller than the largest extension of the filter apparatus. The protrusion may be formed in the underside by rounded edges. The protrusion may have a height of between 1 cm and 2.5 cm in its flattest region. In an embodiment, the largest extension of the protrusion is maximum 15.5 cm. The maximum extension of the filter apparatus may then be greater than the maximum extension of the protrusion.

In an embodiment, an insertion region projecting downwards is arranged on the underside for insertion into the opening. The insertion region can have an approximately circular-cylindrical outer cross-section, which is arranged axially and/or centrally with respect to an axis of rotational symmetry of the filter apparatus. The insertion region may be in the form of a tube having a circular cross-section. The insertion region may have an outer surface that is rubberized, flexible, and/or coated with an adhesive material so that it provides a certain degree of sealing when inserted into the opening. In this way, a particularly large proportion of the steam produced can be filtered.

In one embodiment, the inflow opening is circular and/or centered with respect to an axis of rotational symmetry or center axis of the filter apparatus. In one embodiment, the inflow opening has a diameter of at least 4 cm, preferably at least 5 cm, and/or at most 11 cm, preferably at most 9 cm. In this way, steam from the cooking process can enter the filter apparatus particularly reliably during operation.

The filter apparatus encloses the space for receiving the filter material. In this way, the filter material can be reliably separated from a food to be prepared. Easy changing of the filter material is thus also enabled. The space can be enclosed completely or partially, such as by a half shell forming the underside.

In an embodiment, the external shape of the filter apparatus is substantially rotationally symmetrical, preferably with respect to a main direction of flow of the steam and/or the central axis of the filter apparatus. Rotational symmetry means that the filter apparatus is projected onto itself at various angles of rotation, in particular at arbitrary angles. The rotational symmetry refers to the outer contour of the filter apparatus. In particular, the central axis corresponds to the axis of rotational symmetry, which also applies in an analogous manner to the foregoing and subsequently described embodiments.

The main direction of flow is vertical when used as intended. In the case of a substantially rotationally symmetrical shape, minor deviations from the rotationally symmetrical shape, such as for example bore holes and recesses for fastening means or, for example, a grille in the inflow opening, need not be taken into account. In an embodiment, the filter apparatus substantially has a basic shape of an ellipsoid, in particular the basic shape of a rotational ellipsoid. Therein, the filter apparatus is in particular flatter axially than it is wide radially. In particular, the largest extension of the ellipsoid can be predetermined by a diameter of the ellipsoid measured perpendicular to the main direction of flow. It is further possible in general and provided in one embodiment that the outer shape of the filter apparatus is a spherical shape. In one embodiment, the outer shape of the filter apparatus is substantially mirror-symmetrically shaped with respect to a central plane extending perpendicular to the main direction of flow of the steam and/or horizontally. Due to the equal distances along the circumference, this design enables a particularly uniform flow through the filter material, so that its capacity is utilized optimally and a long operating time of the filter apparatus is possible.

In an embodiment, the extension of the filter apparatus, the extension of the space for the filter material and/or the extension of a filter unit with the filter material transverse to the main direction of flow is greater than in the main direction of flow, preferably at least 1.5 times greater, preferably at least 2 times greater, and/or at most 5 times greater, preferably at most 3 times greater. The flow resistance for the steam passing through the filter material can be kept comparatively low in this way, so that a reliable sealing can be achieved by means of a liquid film.

In one embodiment, the underside is shaped such that the filter apparatus can rest on an even or funnel-shaped base at the underside with a (in particular closed) circumferential contact line or contact surface. Through the contact line or contact surface, a liquid film is formed during operation, which has a sealing effect. The dead weight of the filter apparatus filled with filter material having the minimum dimensions as mentioned above is sufficient for this purpose. Hence, the filter apparatus, when in a state of lying on, enables a sealing against a substrate without any additional components or sealings. In this way, the filter apparatus also requires no additional fastening. In operation and during a cooking process, the formation of excess pressure in the food preparation vessel is thus prevented additionally. Lying on flat enables the formation of a particularly effective water film sealing. Therein, condensed water from the steam gets between the surfaces of the filter apparatus and the material forming the opening contacting each other and seals off the internal space of the food preparation vessel and the inflow opening from the surroundings in a simple and effective manner, such that the generated steam is directed through the filter apparatus as completely as possible. The larger the contact surface, the greater the sealing effect. In operation, the substrate corresponds to a surface of a lid that extends around the opening. The outer contour of the underside of the filter apparatus allows to draw a closed circular line in an in particular horizontal plane, in particular around a central axis of the filter apparatus, which forms the contact line when the apparatus is positioned. The outer contour contains a surface section which, as a circumferential contact surface, has the form of a closed circular ring extending over 360° around a central axis. The circular ring is radially limited by two circular lines as described above. The contact line or contact surface extend around the entire circumference with respect to the main direction of flow and/or around the center axis, so that the contact line or contact surface completely encloses the opening during operation and intended use.

The contact surface is preferably circular. Typically, the area of the contact surface is smooth. In particular, the average peak-to-valley height is less than 25 μm, preferably less than 3 μm. In an embodiment, the inflow opening is completely enclosed by the contact line or contact surface in the circumferential direction.

In an embodiment, the filter apparatus comprises an outer housing in which the space is formed or arranged. Preferably, the outer housing is made of plastic. The outer housing encloses the space at least partially. It forms the underside. It is possible that the space is formed by the entire inner volume of the outer housing and/or that this inner volume is filled with filter material or a filter unit with the filter material. The outer housing may be formed in one piece or in several pieces. In the case of a multi-part housing, the parts may be connected in a fixed manner or may be reversibly connectable. In particular, the outer housing comprises a lower housing part defining the lower side of the filter apparatus. In an embodiment, the outer housing comprises an upper housing part defining an upper side of the filter apparatus. The upper housing part and/or the lower housing part may further define at least a portion of a lateral surface of the filter apparatus. In one embodiment, the upper housing portion and the lower housing portion are formed as bowl-shaped elements, also referred to as half-shells.

Plastics are durable, easy to clean and have low thermal conductivity. The filter apparatus can thus be used to purify steam without the user being at risk of being burned on contact.

In an embodiment, the filter apparatus has an upper housing part with an outflow opening for filtered steam. The upper housing part forms the upper side of the filter apparatus, which can be opposite the underside. The steam thus flows through the filter apparatus from bottom to top along the main direction of flow. This enables a uniform and complete flow through the filter material with low technical effort.

In an embodiment, the filter apparatus has a lower housing part with the inflow opening and/or an upper housing part with an outflow opening for filtered steam. A particularly simple and robust configuration is thus achieved. In an embodiment, the outflow opening is circular and/or centered with respect to an axis of rotational symmetry and/or center axis of the filter apparatus. In an embodiment, the outflow opening has a diameter of at least 4 cm, preferably at least 5 cm, and/or at most 11 cm, preferably at most 9 cm. Preferably, the diameter of the outflow opening corresponds to the diameter of the inflow opening. The above-mentioned diameters ensure a particularly uniform flow of steam.

In a further embodiment, the filter apparatus has connecting means by which the upper housing part and the lower housing part can be mechanically connected to one another, in particular in a manually releasable manner. In other words, the upper housing part and the lower housing part can be held in a closed position. In the closed position, the upper housing part and the lower housing part enclose the space together and hold the filter material. The connecting means may be arranged on the upper housing part and/or the lower housing part and/or be formed by them. In an embodiment, respective connecting means of the upper housing part and the lower housing part may cooperate directly to connect the two parts with each other. In another embodiment, a middle part may be arranged between the upper housing part and the lower housing part, on which the connecting means for connecting the upper housing part and the lower housing part are arranged or formed. The middle part can be mechanically connectable or connected to both the upper housing part and the lower housing part. The middle part can be reversibly connectable to at least one of the sides.

In an embodiment, the connecting means comprises a bayonet lock. Alternatively or additionally, a screw closure or locking means can be provided for form-fitting connection, e.g. in the form of a snap closure. For example, a locking element and a corresponding locking recess may be provided, which are elastically movable with respect to each other. When a bayonet lock is used, the upper housing part and the lower housing part can be moved from an open position to a closed position and vice versa by means of a translatory and/or rotatory relative movement.

In an embodiment, the upper housing part and the lower housing part are identical in construction or have the same or substantially the same external shape. In particular in an assembled state, they may be formed symmetrically with respect to a horizontal plane. Minor deviations are not to be taken into account, for example due to differing parts of connecting means. A reversible or releasable connection allows manual opening and re-closing by the user in order to replace the filter material.

In an embodiment, the filter apparatus comprises the filter material for filtering for filtering the steam arranged in the space. The filter material may be part of a filter unit which is positionable or positioned in the space. The filter material may be arranged in an at least regionally steam-permeable bag as a filter unit, which can be introduced into the space in a particularly simple manner and may be replaced if necessary. Accordingly, the filter apparatus can be configured to receive a bag containing the filter material.

The filter material may contain a filter packing, i.e. a particulate solid, which in particular has a large inner surface area. The filter material may contain one or more filter elements, which may be traversed by channels. The filter material may include a depth filter and/or a surface filter. The filter material may include a filter layer, a membrane filter and/or a filter fleece, filter fabric, filter paper. The filter material may include an optionally porous solid that may include flow channels. In an embodiment, the inflow opening and/or outflow opening may be a pore. In an embodiment, the filter material is cohesively attached. The filter material may be bonded or overmolded and/or may be in the form of loose fill. The filter material can be held by at least one and in particular two grids or membranes, wherein the grids or membranes are steam-permeable.

In an embodiment, the filter material is arranged in a filter unit that is positionable or positioned in the space. The filter unit improves the central and uniform conduction of the steam and thus enables a complete flow through the available volume of the filter material. Thus, dead zones are avoided and the capacity of the filter material is optimally utilized.

The use of a filter unit with a manually deformable, gas-permeable casing also enables easy replacement of the filter unit and low manufacturing costs. The use of a filter unit with a hard filter housing made of plastic, for example, allows the filter material to be arranged in such a way that the steam can flow through the filter material, especially activated carbon, in a particularly uniform manner. The filter unit and/or the filter housing may be formed substantially rotationally symmetrical. An annular, flat and/or circumferential fastening section preferably made of plexiglass can be radially adjacent to the filter unit to hold the filter unit centrally in position and/or to fix the above-described connecting means for the housing upper shell and/or housing lower shell inside the filter apparatus. The fastening section can be held by an outer housing of the filter apparatus. The fastening section is in particular in the form of a circular ring, which is in particular centered on the central axis. The filter unit with filter housing and/or the fastening section can form a middle part which can be arranged between the upper housing part and the lower housing part and/or which can be held in an intended position by its adapted outer shape.

In an embodiment, the filter housing of the filter unit has a cylindrical outer contour. When the filter unit is received in the space of the filter apparatus, the cylindrical axis of the filter housing lies on the central axis of the filter apparatus. Preferably, the closed outer surface of the cylindrical outer contour is impermeable to gas and/or a structure with channels parallel to the central axis, preferably running in a straight line, extends from a lower inflow side to an upper outflow side. The channels are separated from each other by walls. Preferably, all channels run parallel to each other. In particular, the walls form a honeycomb structure such that, viewed in cross-section, polygonal channels are formed. Preferably, at least 10 and/or at most 20 channels are arranged next to each other when viewed in cross-section over the diameter of the filter housing. The diameter of the filter housing is greater than its height in the direction of the center axis, preferably 1.5 to 2.5 times greater. In particular, the diameter of the filter housing is at least 0.9 times and/or at most 1.2 times, preferably 1 times, the diameter of the inflow opening and/or the outflow opening. The steam entering the filter apparatus through the inflow opening distributes through the channels and interacts with the filter material contained therein. In particular on the inlet side and/or the opposite outlet side, a retaining element such as a grid or a membrane made of fabric is provided for retaining the filter material. In an embodiment, the filter material fills the filter housing without an internal channel structure and/or a honeycomb grid or mesh extends over the entire inflow side and/or outflow side for supporting a retaining element and/or for retaining the filter material. When the filter unit has a deformable casing, the filter material fills the interior of the casing, preferably without an internal support structure or channel structure inside the casing.

In one embodiment, the filter apparatus comprises activated carbon as the filter material. Activated carbon is very efficient for removing odors from steam from food preparation. When using activated carbon and an outer housing made of plastic, the amount of filter material resulting from the geometric specifications is well suited to achieve an overall weight of the filter apparatus that provides a sufficient sealing with the material forming the opening. In particular, granulated activated carbon is used.

In a further embodiment, a grille extends over the complete inflow opening and/or over the complete outflow opening. The grille can be configured to at least partially remove grease and/or oil splashes carried along with the steam from the steam. The grille may be designed as part of a grease filter, which is configured such that it removes finely distributed grease and/or oil droplets from the steam. The grille may comprise or be designed as a metal filter. The grille may be in the form of a sieve, mesh or fabric, preferably made of metal wire or expanded metal. The grille may comprise one or several layers. Alternatively or additionally, a non-woven fabric layer can be provided for separating grease or oil. The filter material is thus protected from contamination and mold growth is counteracted.

In one embodiment, a grille, preferably a metal grille, extends over the complete inflow opening and/or the complete outflow opening. In this way, the filter material can be retained particularly reliably within the filter apparatus. Moreover, the metal grille can fulfill an additional function, that is, to keep off grease splashes and grease droplets that settle on the grille from the steam. In particular, the metal grille has a mesh size of at least 0.5 mm and/or at most 1 mm. The metal grille may form an outer contour of the filter apparatus.

In one embodiment, the filter apparatus has a motor-driven blower. Gas such as steam or air can be actively suctioned into the filter apparatus in this way. Preferably, the motor for the blower is operated with the aid of a rechargeable battery. Alternatively, the motor can be powered by electrical contacts that can be connected to a power outlet or to an electrical interface of a kitchen appliance. In one embodiment, the filter apparatus includes a reservoir for condensed water and/or holes for draining condensed water.

A further aspect of the disclosure relates to a filter apparatus for a kitchen appliance for filtering steam from a food preparation with the kitchen appliance, wherein the filter apparatus has an inflow opening for steam at an underside of the filter apparatus, wherein the filter apparatus encloses a space for receiving a filter material for filtering steam, wherein the filter apparatus is dimensioned such that the filter apparatus can cover a circular opening having a diameter of 6 cm and is configured such that the filter apparatus cannot be pushed through the opening, wherein the filter apparatus has a largest extension between 22 cm and 50 cm. This aspect of the disclosure, which serves the use in extreme applications in the field of food preparation, enables the use of special filters to filter out special constituents and/or to achieve a particularly high filter rate. For example, a multi-layer filter material or several layers of different filter materials can be used so that the steam passes through a particularly large filter surface and/or several filter stages arranged in sequence. The filter apparatus may increase in cross-section towards the top so that a larger filter surface area and/or a larger filter volume is provided. The filter apparatus may have directing elements for distributing the steam flow inside the filter material and/or between units of the filter material. The filter material may comprise a filter layer such as a filter fleece that is pleated, for example, and/or a filter packing. The filter material may include depth filters and/or surface filters. The filter material may comprise a HEPA filter (High-Efficiency Particulate Air/Arrestance), i.e. a high-efficiency suspended particle filter, for example corresponding to classification H13 or H14 according to EN 1822-1:2009. All features, embodiments and effects of the filter apparatus described above may also apply to this aspect correspondingly.

Another aspect of the disclosure relates to a kitchen appliance for preparing a food in a food preparation vessel. The kitchen appliance comprises a heating element for heating a food in the food preparation vessel and/or a tool for mixing or comminuting the food in the food preparation vessel. It further comprises the removable food preparation vessel. The kitchen appliance comprises a filter apparatus for filtering steam from the food preparation vessel during a food preparation operation.

The filter apparatus may be a separate part, for example a filter apparatus according to the aspect of the disclosure described at the outset. The kitchen appliance may comprise a lid for closing the food preparation vessel. This may have a circular opening in particular arranged centrally, over which the filter apparatus may be positioned. All features, embodiments and effects of the filter apparatus described at the outset may apply accordingly to the filter apparatus of the kitchen appliance.

The filter apparatus may be integrated into the kitchen appliance and configured to filter steam released from the food preparation vessel during a food preparation operation. In particular, the filter apparatus has an inflow opening for steam to be filtered, a filter material, and an outflow opening for filtered steam. In particular, the filter apparatus is configured such that the filter material can be replaced. For this purpose, the filter apparatus is preferably accessible from the outside. It can be arranged in a housing of the kitchen appliance.

In an embodiment, the kitchen appliance has a suction device by which steam released from the food preparation vessel during a food preparation process can be sucked off and directed to the filter apparatus.

During operation, the steam is released through the opening in the lid of the food preparation vessel. In particular, the suction device comprises a suction opening arranged near the upper side of the food preparation vessel. A distance between the suction opening and the opening in the lid of the food preparation vessel is in particular smaller than 15 cm, preferably smaller than 10 cm. The distance is defined as the shortest distance between an edge of the opening and a nearest section of the suction opening, for example an exhaust air grille closing the suction opening. Due to such small distances, the steam can be sucked off in an energy-saving manner, noise emission can be reduced and a very efficient cleaning of the steam can take place.

The suction device in particular comprises a blower for conveying an air stream containing the steam. The blower can be driven by an electric motor. The blower is configured to suck in the steam and to convey it through the filter apparatus. In particular, the kitchen appliance has an exhaust air duct for exhausting the steam from the kitchen appliance. The filter apparatus is preferably arranged downstream of the blower. Hereby, the blower has an increased service life. Alternatively, the filter apparatus may be arranged upstream of the blower.

In an embodiment, the kitchen appliance has an electric motor for driving the tool that is also configured to drive a blower of the suction device. The electric motor can thus be configured for both functions. In particular, the blower and the tool can be used independently of each other. An appropriately configured transmission can be provided.

In another embodiment, the kitchen appliance has a carrying handle for carrying the kitchen appliance and a suction opening of the suction device is arranged in the carrying handle, in particular in a section of the carrying handle above the food preparation vessel. The suction opening is used to draw in and suck off the generated steam and/or generated odors. The suction opening is secured in particular by an exhaust air grille to prevent objects from being accidentally sucked in or falling in.

The carrying handle is tube-like so that the exhaust air duct can run through the carrying handle to the suction opening. In particular, the filter is arranged in a lower and/or rear part of the kitchen appliance and/or outside the carrying handle. According to this embodiment, suction is particularly easy to integrate into an existing kitchen appliance design in terms of construction. In an embodiment, the suction opening of the suction device is slit-shaped. Thus, a particularly fast-flowing stream of air can be generated and the steam can be sucked off very efficiently. In particular, the width of the slit is at least 2 and/or at most 10 mm. Preferably, the slit length is at least 10 cm and/or at most 20 cm. Preferably, only a single suction opening is provided. The above-described configurations allow sufficient and at the same time efficient drawing in.

In an embodiment, the kitchen appliance has a device for separating water from the steam and/or a collecting tank for collecting the separated water. In particular, the device for separating water comprises a cooling element for cooling the steam for the purpose of condensing the water contained in the steam.

The cooling element serves to cool a surface in contact with the steam. Water can thus condense on the surface. In particular, an active cooling element such as a Peltier element is used as the cooling element. In particular, the kitchen appliance may be configured such that the condensed water flows into the collection tank due to gravity.

For this purpose, a suitably oriented channel for draining the water vapor is arranged between the surface and the tank. The channel may be part of the exhaust air duct. Thus, the steam can be sucked away from an upper side of the food preparation vessel by an air flow generated in an exhaust air duct. The steam may be cooled in the exhaust air duct by the cooling element so that water contained condenses. The steam can then be released from an air outlet, for example at the rear of the kitchen appliance and/or at the side. For the sake of simplicity, the exhaust air stream from which the water has been at least partially removed is also referred to as steam herein. The release of the steam can be done in a directed manner. The filter apparatus is preferably located downstream of the surface that can be cooled by the Peltier element. The service life can thus be increased. Alternatively, the filter apparatus can also be arranged downstream of the surface that can be cooled by the Peltier element.

The collection tank is in particular removable so that it can be emptied in a simple manner. The kitchen appliance can have a sensor for determination of a filling level of the collection tank. The kitchen appliance can be configured to output a corresponding signal to the user when the collection tank is full, for example by means of an output unit of the kitchen appliance. This design enables the release of exhaust air with a low water content. This is advantageous for furniture such as kitchen cabinets, on which moisture can cause damage.

In the following, exemplary embodiments of the disclosure are also explained in more detail with reference to figures. Features of the embodiment examples can be combined individually or in a plurality with each other and with the claimed and described subject matter, unless otherwise indicated. The claimed scope of protection is not limited to the embodiments.

1. A kitchen appliance for preparing food, the kitchen appliance comprising:
a removable food preparation vessel,
a heating element for heating food in the food preparation vessel,
a tool for mixing or comminuting the food in the food preparation vessel, and
a filter apparatus for filtering steam from the food preparation vessel during a food preparation operation, wherein the filter apparatus comprises:
an inflow opening for steam on an underside of the filter apparatus,
wherein the filter apparatus encloses a space for receiving a filter material for filtering steam,
wherein the filter apparatus is dimensioned such that the filter apparatus is configured to cover a circular opening with a diameter of 6 cm and is configured such that the filter apparatus cannot be pushed through the opening,
wherein a largest dimension of the filter apparatus does not exceed 22 cm, preferably does not exceed 15.5 cm,
the kitchen appliance comprising a lid for closing the food preparation vessel, the lid having a circular opening, the circular opening having a diameter that does not exceed 6 cm, and
wherein, in a filtering position of the filter apparatus, the filter apparatus is positioned on said lid and covers said circular opening completely.

2. A filter apparatus for a kitchen appliance for filtering steam from food preparation with the kitchen appliance, the filter apparatus comprising:
an inflow opening for steam on an underside of the filter apparatus,
wherein the filter apparatus encloses a space for receiving a filter material for filtering steam,
wherein the filter apparatus is dimensioned such that the filter apparatus is configured to cover a circular opening with a diameter of 6 cm and is configured such that the filter apparatus cannot be pushed through the opening, and
wherein a largest dimension of the filter apparatus does not exceed 22 cm, preferably does not exceed 15.5 cm.

3. The filter apparatus of claim 2, wherein an outer shape of the filter apparatus is substantially rotationally symmetrical, and wherein the outer shape of the filter apparatus is rotationally symmetrical with respect to a main direction of flow of the steam.

4. The filter apparatus of claim 3, wherein a first dimension of the filter apparatus extending transversely to the main direction of flow is greater than a second dimension of the filter apparatus that extends in the main direction of flow.

5. The filter apparatus of claim 2, wherein the underside is shaped such that the filter apparatus is configured to rest on at least one of an even base or a funnel-shaped base disposed at the underside of the filter apparatus, wherein the at least one of the even base or the funnel-shaped base includes a circumferential contact line or a contact surface.

6. The filter apparatus of claim 3, wherein the filter apparatus includes an outer housing, wherein a material of the outer housing includes plastic, and wherein the outer housing defines the space therewithin.

7. The filter apparatus of claim 6, wherein the filter apparatus includes a lower housing part with the inflow opening and an upper housing part with an outflow opening for filtered steam.

8. The filter apparatus of claim 7, wherein the filter apparatus includes a filter material for filtering the steam, wherein the filter material is disposed in the space.

9. The filter apparatus of claim 8, wherein the filter material is arranged in a filter unit disposed in the space, wherein the filter unit is rotationally symmetrical and includes a circumferential fastening section extending radially outwards, and wherein the circumferential fastening section is configured to couple to an outer housing of the filter apparatus.

10. The filter apparatus of claim 9, wherein a filter material of the filter apparatus includes activated carbon.

11. The filter apparatus of claim 10, further comprising a grille extending over an entire area of the inflow opening.

12. A kitchen appliance for preparing food, the kitchen appliance comprising:
a removable food preparation vessel,
a heating element for heating food in the food preparation vessel,
a tool for mixing or comminuting the food in the food preparation vessel, and
a filter apparatus for filtering steam from the food preparation vessel during a food preparation operation,
the kitchen appliance further comprising a suction device configured to suck off steam released from the food preparation vessel during the food preparation operation and direct the steam to the filter apparatus.

13. The kitchen appliance of claim 12, further comprising an electric motor configured to drive the tool, wherein the electric motor is configured to drive a blower of the suction device.

14. The kitchen appliance of claim 12, further comprising a carrying handle for carrying the kitchen appliance, wherein the carrying handle defines a suction opening.

15. The kitchen appliance of claim 12, further comprising a device for separating water from the steam and a collecting tank for collecting the separated water, wherein the device for separating water includes a cooling element for cooling the steam for condensing the water.
